(19) United States
(12) Patent Application Publication
(10) Pub. No.: US 2023/0246264 A1
(43) Pub. Date: Aug. 3, 2023

(54) BATTERY MODULE

(71) Applicant: Prime Planet Energy & Solutions, Inc., Tokyo (JP)

(72) Inventor: Daisuke NAIKI, Kasai-shi (JP)

(21) Appl. No.: 18/091,374

(22) Filed: Dec. 30, 2022

(30) Foreign Application Priority Data
Feb. 3, 2022 (JP) 2022-015552

(51) Int. Cl. H01M 10/6556; H01M 10/613; H01M 10/6567; H01M 50/209

(52) U.S. Cl. CPC H01M 10/6556; H01M 10/613; H01M 10/6567; H01M 50/209

(57) ABSTRACT

A battery module includes a plurality of battery cells and a cooling mechanism. The plurality of battery cells are arranged side by side in a first direction. The cooling mechanism is disposed adjacent to each of the plurality of battery cells and cools the plurality of battery cells. The cooling mechanism includes a flow path portion. The flow path portion extends inside the cooling mechanism along each of the plurality of battery cells in the first direction, and cooling water can flow therethrough. Heat resistance of the cooling mechanism with respect to the plurality of battery cells is decreased in a direction from an upstream toward a downstream of the flow path portion.

This nonprovisional application is based on Japanese Patent Application No. 2022-015552 filed on Feb. 3, 2022 with the Japan Patent Office, the entire contents of which are hereby incorporated by reference.

### BACKGROUND OF THE INVENTION

### Field of the Invention

The present technology relates to a battery module.

### Description of the Background Art

Japanese Patent Laying-Open No. 2013-016301 is a prior art document that discloses a configuration of a power storage module. The power storage module described in Japanese Patent Laying-Open No. 2013-016301 includes a battery pack, a cooling structure portion, a case, and a fan. In the battery pack, a plurality of battery cells are electrically connected together. The cooling structure portion is disposed to be thermally coupled to the battery cells. A cooling medium flows into the cooling structure portion to cool the battery cells. The case accommodates the battery pack and the cooling structure portion. The fan is disposed in the case. The fan sends air in the case toward the cooling structure portion side for the sake of convection of the air in the case, thereby cooling the battery cells by the convection air.

### SUMMARY OF THE INVENTION

In the power storage module described in Japanese Patent Laying-Open No. 2013-016301, heat exchange is performed between the cooling medium and heat generated by a battery cell at the upstream of the flow of the cooling medium into the cooling structure portion, with the result that the temperature of the cooling medium is increased at the downstream. In this case, since a battery cell on the downstream side is not sufficiently cooled by the cooling medium, the temperature of the battery cell on the downstream side is increased as compared with the battery cell on the upstream side, with the result that variation in battery cell temperatures may occur among the plurality of battery cells.

The present technology has been made to solve the above-described problem and has an object to provide a battery module to suppress variation in battery cell temperatures among a plurality of battery cells.

A battery module according to the present technology includes a plurality of battery cells and a cooling mechanism. The plurality of battery cells are arranged side by side in a first direction. The cooling mechanism is disposed adjacent to each of the plurality of battery cells and cools the plurality of battery cells. The cooling mechanism includes a flow path portion. The flow path portion extends inside the cooling mechanism along each of the plurality of battery cells in the first direction, and cooling water is able to flow through the flow path portion. Heat resistance of the cooling mechanism with respect to the plurality of battery cells is decreased in a direction from an upstream toward a downstream of the flow path portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery module according to a first embodiment of the present technology.

FIG. 2 is a perspective view showing the configuration of the battery cell according to the first embodiment of the present technology.

FIG. 3 is a cross sectional view of the battery module of FIG. 1 when viewed in a direction of arrows of a line III-III.

FIG. 4 is a graph showing results of evaluations on a temperature of a battery cell, a temperature of cooling water flowing through a cooling mechanism, and heat resistance of the cooling mechanism with respect to a position in a flow path portion of the cooling mechanism in the battery module according to the first embodiment of the present technology.

FIG. 5 is a cross sectional view showing a configuration of a battery module according to a second embodiment of the present technology.

FIG. 6 is a perspective view showing a configuration of a cooling mechanism included in a battery module according to a third embodiment of the present technology.

FIG. 7 is a perspective view showing a configuration of a cooling mechanism included in a battery module according to a fourth embodiment of the present technology.

FIG. 8 is a cross sectional view showing a configuration of a battery module according to a fifth embodiment of the present technology.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly.

It should be noted that in the present specification, the terms “comprise”, “include”, and “have” are open-end terms. That is, when a certain configuration is included, a configuration other than the foregoing configuration may or may not be included. Further, the present technology is not limited to one that necessarily exhibits all the functions and effects stated in the present embodiment.

In the present specification, the term “battery” is not limited to a lithium ion battery, and may include another battery such as a nickel-metal hydride battery. In the present specification, the term “electrode” may collectively represent a positive electrode and a negative electrode. Further, the term “electrode plate” may collectively represent a positive electrode plate and a negative electrode plate.

It should be noted that in each of the figures, an X direction represents a direction orthogonal to a stacking direction of the battery cells and orthogonal to a height direction of each of the battery cells, a Y direction represents the stacking direction of the battery cells, and a Z direction represents the height direction of each of the battery cells.

### First Embodiment)

FIG. 1 is a perspective view showing a configuration of a battery module according to a first embodiment of the present technology. As shown in FIG. 1, a battery module 1 according to the first embodiment of the present technology includes battery cells 100, end plates 200, restraint members 300, and a cooling mechanism 400.

The plurality of battery cells 100 are arranged side by side in the first direction (Y direction). A separator (not shown) is interposed between battery cells 100. The plurality of battery cells 100, which are sandwiched between two end plates 200, are pressed by end plates 200, and are therefore restrained between two end plates 200.

End plates 200 are provided at both ends of the plurality of battery cells 100 in the first direction (Y direction). Each of end plates 200 is fixed to a base such as a housing that accommodates battery module 1. End plate 200 is composed of, for example, aluminum or iron.

As shown in FIG. 1, restraint members 300 are provided at both ends of the plurality of battery cells 100 and end plates 200 in the X direction. When each of restraint members 300 is engaged with end plates 200 with compressive force in the Y direction being applied to the plurality of stacked battery cells 100 and end plates 200 and then the compressive force is released, tensile force acts on restraint member 300 that connects two end plates 200. As a reaction thereto, restraint member 300 presses two end plates 200 in directions of bringing them closer to each other. As a result, restraint member 300 restrains the plurality of battery cells 100 in the Y direction.

Cooling mechanism 400 is disposed adjacent to each of the plurality of battery cells 100 and cools the plurality of battery cells 100. Cooling mechanism 400 in the present embodiment is provided on the lower surface 122 side of a case body 120 described later.

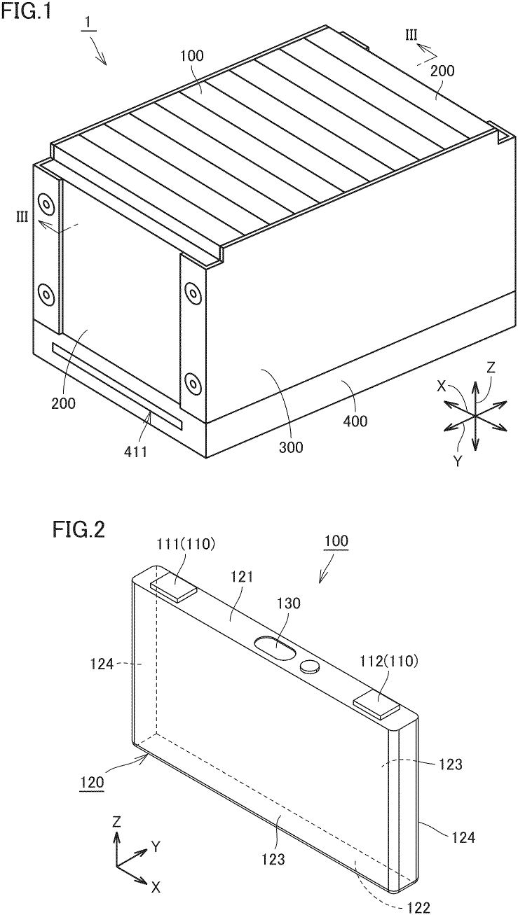

FIG. 2 is a perspective view showing a configuration of a battery cell according to the first embodiment of the present technology. As shown in FIG. 2, each of the plurality of battery cells 100 includes electrode terminals 110, case body 120, and a gas-discharge valve 130.

Electrode terminals 110 have a positive electrode terminal 111 and a negative electrode terminal 112. Electrode terminals 110 are formed on case body 120.

Case body 120 is a container that accommodates an electrode assembly (not shown) and an electrolyte solution (not shown). Case body 120 has a substantially rectangular parallelepiped shape. Case body 120 is composed of aluminum, an aluminum alloy, iron, an iron alloy, or the like.

Case body 120 has an upper surface 121, a lower surface 122, a pair of long side surfaces 123, and a pair of short side surfaces 124.

Electrode terminals 110 are disposed on upper surface 121. Lower surface 122 is opposite to upper surface 121 in the third direction (Z direction).

The pair of long side surfaces 123 and the pair of short side surfaces 124 constitute side surfaces of case body 120. The pair of long side surfaces 123 and the pair of short side surfaces 124 serving as the side surfaces of case body 120 intersect each of upper surface 121 and lower surface 122. The pair of long side surfaces 123 are opposite to each other in the first direction (Y direction). The pair of short side surfaces 124 are opposite to each other in the second direction (X direction). Each of the pair of long side surfaces 123 has a larger area than that of each of the pair of short side surfaces 124.

Gas-discharge valve 130 is fractured when pressure inside case body 120 becomes equal to or more than a predetermined value. Thus, gas in case body 120 is discharged to outside of case body 120.

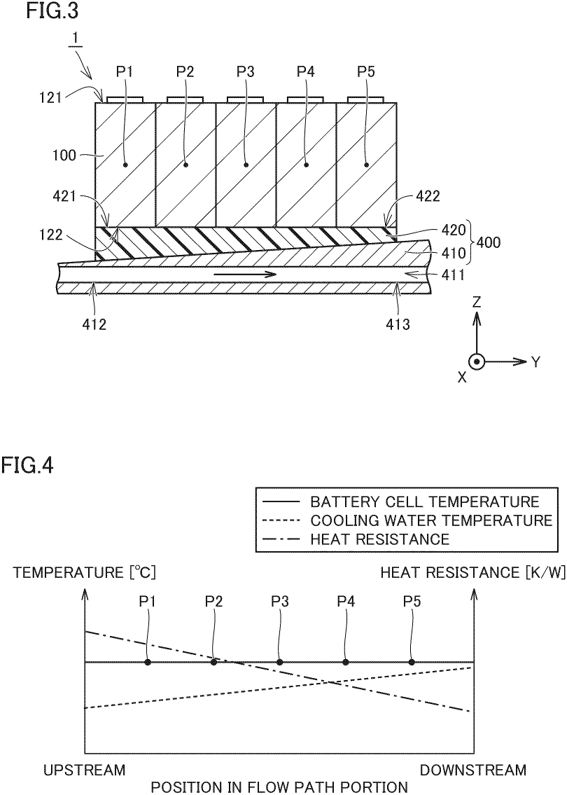

FIG. 3 is a cross sectional view of the battery module of FIG. 1 when viewed in a direction of arrows of a line III-III. In FIG. 3, in order to facilitate understanding of the invention, the number of the plurality of battery cells 100 is five.

As shown in FIG. 3, cooling mechanism 400 includes a cooling member 410 and a heat conduction member 420.

Cooling member 410 according to the present embodiment is in the form of a plate. Cooling member 410 is composed of aluminum or an aluminum alloy, for example. Heat conductivity of cooling member 410 according to the present embodiment is 220 W/(m·K), for example.

Cooling member 410 has a flow path portion 411. Flow path portion 411 extends inside cooling mechanism 400 along each of the plurality of battery cells 100 in the first direction (Y direction), and cooling water can flow therethrough. In flow path portion 411, the cooling water flows from upstream 412 toward downstream 413 as indicated by a direction of arrow in the figure.

Flow path portion 411 in the present embodiment is formed, for example, by inserting a pipe (not shown) into cooling member 410. It should be noted that flow path portion 411 is not limited to such a structure formed by the pipe, and may be formed by forming a hole or the like in cooling member 410.

The thickness of cooling member 410 is thicker in the direction from upstream 412 toward downstream 413 of flow path portion 411. The thickness of cooling member 410 of the present embodiment is thicker on the battery cell 100 side with respect to flow path portion 411. Since the heat conductivity of cooling member 410 is higher than the heat conductivity of heat conduction member 420 described later, the change in the thickness of cooling member 410 has a small influence over the heat resistance of cooling mechanism 400 in the direction from upstream 412 toward downstream 413.

Heat conduction member 420 is adjacent to the plurality of battery cells 100 and cooling member 410 and sandwiched between each of the plurality of battery cells 100 and cooling member 410. Heat conduction member 420 in the present embodiment is in the form of a sheet. Heat conduction member 420 is composed of, for example, a silicone resin.

Heat conduction member 420 has a lower heat conductivity than that of cooling member 410. The heat conductivity of heat conduction member 420 in the present embodiment is, for example, 3 W/(m·K).

Heat conduction member 420 may be composed of a silicone-based resin curable from a gel state. In this case, heat conduction member 420 is, for example, a silicone-based resin having heat conductivity, wherein the silicone-based resin is in a gel state as an initial state and is cured to be a solid after being applied, such as a gap filler. When such a silicone-based resin curable from the gel state is used, the shape of heat conduction member 420 is readily changed because the initial state is the gel state.

Heat conduction member 420 includes a first portion 421 and a second portion 422. First portion 421 is located between battery cell 100 and upstream 412 of cooling member 410. Second portion 422 is located between battery cell 100 and downstream 413 of cooling member 410.

The thickness of heat conduction member 420 is thinner in the direction from upstream 412 toward downstream 413 of flow path portion 411. In heat conduction member 420 of the present embodiment, the thickness of second portion 422 is thinner than the thickness of first portion 421.

If the thickness of heat conduction member 420 is changed in the same manner as the change in thickness of cooling member 410, heat conduction member 420 has a larger influence over the heat resistance of cooling mechanism 400 than cooling member 410 because heat conduction member 420 has a lower heat conductivity than that of cooling member 410. Therefore, the thickness of heat conduction member 420 is made thinner in the direction from upstream 412 toward downstream 413 of flow path portion 411, with the result that the heat resistance of cooling mechanism 400 with respect to the plurality of battery cells 100 is decreased in the direction from upstream 412 toward downstream 413 of flow path portion 411.

It should be noted that the thickness of each of cooling member 410 and heat conduction member 420 in the present embodiment is continuously changed; however, it is not limited to this configuration and the thickness may be stepwisely changed, for example.

Here, the following describes results of evaluations on a temperature of battery cell 100, a temperature of the cooling water flowing through cooling mechanism 400, and heat resistance of cooling mechanism 400 with respect to a position in flow path portion 411 of cooling mechanism 400 in battery module 1 according to the first embodiment of the present technology.

As conditions for these evaluations, first, cooling member 410 having a thickness that becomes larger in the direction from upstream 412 toward downstream 413, and heat conduction member 420 having a thickness that becomes smaller in the direction from upstream 412 toward downstream 413 were prepared as shown in FIG. 3. Next, each of the plurality of battery cells 100 according to the present embodiment was caused to generate heat, and the cooling water was then allowed to flow through flow path portion 411. Next, the respective temperatures of the plurality of battery cells 100 were measured at temperature measurement positions P1, P2, P3, P4, P5 of the plurality of battery cells 100. On this occasion, the temperature of the cooling water between upstream 412 and downstream 413 was measured, and the heat resistance of cooling mechanism 400 was calculated. It should be noted that each of temperature measurement positions P1, P2, P3, P4, P5 of battery cells 100 according to the present embodiment is located substantially at the center of battery cell 100; however, it is not limited to this configuration and each of temperature measurement positions P1, P2, P3, P4, P5 may be located, for example, on the upper surface 121 side of battery cell 100.

FIG. 4 is a graph showing the results of evaluations on the temperature of the battery cell, the temperature of the cooling water flowing through the cooling mechanism, and the heat resistance of the cooling mechanism with respect to the position in the flow path portion of the cooling mechanism in the battery module according to the first embodiment of the present technology.

As shown in FIG. 4, the temperature of the cooling water flowing through flow path portion 411 is increased in the direction from upstream 412 toward downstream 413 because heat exchange between the cooling water and heat generated in each of the plurality of battery cells 100 is performed in a region from upstream 412 to downstream 413.

Since the thickness of heat conduction member 420 having a lower heat conductivity than that of cooling member 410 is thinner in the direction from upstream 412 toward downstream 413, the heat resistance of cooling mechanism 400 is decreased in the direction from upstream 412 toward downstream 413. The heat resistance of cooling mechanism 400 in the present evaluations was reduced by about 53% in the region from upstream 412 to downstream 413. The heat resistance of cooling mechanism 400 in the present evaluations was about 0.52 K/W at upstream 412 and was about 0.25 K/W at downstream 413.

The respective temperatures of the plurality of battery cells 100 in the present evaluations were substantially the same in the region from upstream 412 to downstream 413. Specifically, it was confirmed that the temperatures of battery cells 100 at temperature measurement positions P1, P2, P3, P4, P5 of the plurality of battery cells 100 were varied by less than about 0.1° C., which is substantially the same.

The temperature of the cooling water is increased in the direction from upstream 412 toward downstream 413; however, by decreasing the heat resistance of cooling mechanism 400 in the direction from upstream 412 toward downstream 413, heat exchange is facilitated at downstream 413 between the cooling water and the heat generated in battery cell 100 as compared with upstream 412, with the result that the temperature of battery cell 100 at downstream 413 can be suppressed from being increased. As a result, the temperatures of the plurality of battery cells 100 can be substantially the same in the region from upstream 412 to downstream 413.

In battery module 1 according to the first embodiment of the present technology, since the heat resistance of cooling mechanism 400 with respect to battery cells 100 is decreased in the direction from upstream 412 toward downstream 413 of flow path portion 411 through which the cooling water flows, the cooling water, which has a temperature to be increased in the direction from upstream 412 toward downstream 413 due to the heat exchange with the plurality of battery cells 100, can be facilitated to perform heat exchange with battery cell 100 at downstream 413 so as to suppress the temperature of battery cell 100 from being increased, thereby suppressing occurrence of temperature variation among the plurality of battery cells 100.

In battery module 1 according to the first embodiment of the present technology, since the thickness of second portion 422 of heat conduction member 420 located at downstream 413 is thinner than the thickness of first portion 421 of heat conduction member 420 located at upstream 412, heat exchange with heat generated in battery cell 100 at downstream 413 of cooling mechanism 400 can be facilitated.

In battery module 1 according to the first embodiment of the present technology, since the thickness of cooling member 410 at downstream 413 is made thicker than the thickness of cooling member 410 at upstream 412, the total thickness of heat conduction member 420 and cooling member 410 can be uniform. Thus, the heat resistance of cooling mechanism 400 can be decreased in the direction from upstream 412 toward downstream 413 while suppressing battery cells 100 from being inclined in the first direction (Y direction).

In battery module 1 according to the first embodiment of the present technology, since heat conduction member 420 is in the form of a sheet, heat conduction member 420 can be inexpensively formed.

In battery module 1 according to the first embodiment of the present technology, when a silicone-based resin curable from a gel state is used for heat conduction member 420, the thickness of heat conduction member 420 can be readily adjusted.

In battery module 1 according to the first embodiment of the present technology, cooling mechanism 400 is disposed on the lower surface 122 side of each of the plurality of battery cells 100, thereby suppressing occurrence of temperature variation among the plurality of battery cells 100.

### Second Embodiment

Hereinafter, a battery module according to a second embodiment of the present technology will be described. Since the configuration of the cooling member of the battery module according to the second embodiment of the present technology is different from that of battery module 1 according to the first embodiment of the present technology, the same configurations as those of battery module 1 according to the first embodiment of the present technology will not be described repeatedly.

FIG. 5 is a cross sectional view showing the configuration of the battery module according to the second embodiment of the present technology. As shown in FIG. 5, a battery module 1A according to the second embodiment of the present technology includes battery cells 100 and a cooling mechanism 400A.

Cooling mechanism 400A includes a cooling member 410A and heat conduction member 420. Cooling member 410A is provided with a flow path portion 411A. The cross sectional area of flow path portion 411A is decreased in the direction from upstream 412A toward downstream 413A of flow path portion 411A

Typically, heat resistance is inversely proportional to the ½ power of a flow velocity of a fluid when the fluid undergoes forced-convection in a laminar flow state. Specifically, a relation of R∝⅟(v^{½}) is satisfied, where R represents the heat resistance and v represents the flow velocity of the cooling water. Moreover, v=Q/S is satisfied, where Q represents a flow rate of the cooling water in flow path portion 411A and S represents a cross sectional area of flow path portion 411A. Therefore, by providing a small cross sectional area S of flow path portion 411A, flow velocity v of the cooling water can be made fast.

In battery module 1A according to the second embodiment of the present technology, since the cross sectional area of flow path portion 411A is smaller in the direction from upstream 412A toward downstream 413A of flow path portion 411A, the heat resistance of cooling mechanism 400A at downstream 413A can be decreased by making the flow velocity of the cooling water at downstream 413A faster than the flow velocity thereof at upstream 412A, with the result that heat exchange between cooling mechanism 400A and battery cell 100 can be efficiently performed at downstream 413A.

### Third Embodiment

Hereinafter, a battery module according to a third embodiment of the present technology will be described. Since the configuration of the cooling mechanism of the battery module according to the third embodiment of the present technology is different from that of battery module 1 according to the first embodiment of the present technology, the same configurations as those of battery module 1 according to the first embodiment of the present technology will not be described repeatedly.

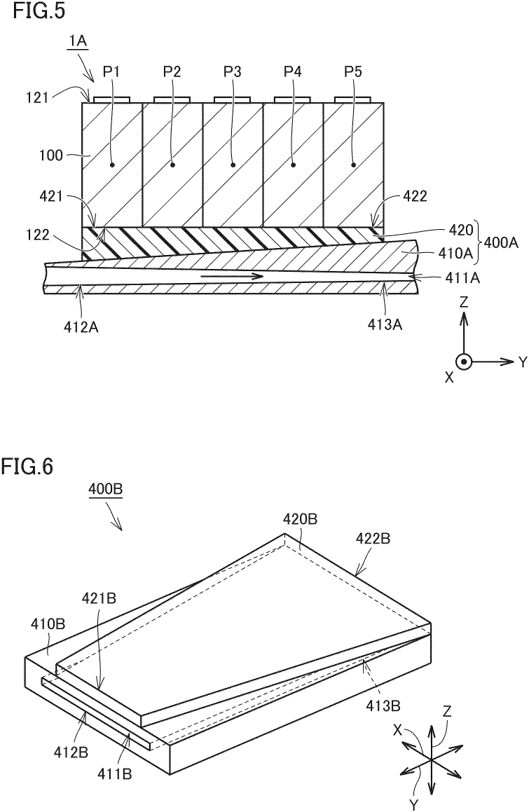

FIG. 6 is a perspective view showing the configuration of the cooling mechanism included in the battery module according to the third embodiment of the present technology. As shown in FIG. 6, a cooling mechanism 400B according to the present embodiment has a cooling member 410B and a heat conduction member 420B.

Cooling mechanism 400B has the same thickness in a region from upstream 412B to downstream 413B. Heat conduction member 420B has the same thickness in a region from a first portion 421B located at upstream 412B to a second portion 422B located at downstream 413B.

Heat conduction member 420B has a wider width in the X direction in the direction from upstream 412B toward downstream 413B. Thus, a region in which the plurality of battery cells and heat conduction member 420 are in contact becomes wider in the direction from upstream 412B to downstream 413B of flow path portion 411B.

In the battery module according to the third embodiment of the present technology, since the region in which heat conduction member 420B is in contact with the battery cell at downstream 413B is wider than that at upstream 412B, heat exchange between the cooling water and the battery cell at downstream 413B can be facilitated to suppress the temperature of the battery cell from being increased, thereby suppressing occurrence of temperature variation among the plurality of battery cells.

### Fourth Embodiment

Hereinafter, a battery module according to a fourth embodiment of the present technology will be described. Since the configuration of the cooling mechanism of the battery module according to the fourth embodiment of the present technology is different from that of battery module 1 according to the first embodiment of the present technology, the same configurations as those of battery module 1 according to the first embodiment of the present technology will not be described repeatedly.

FIG. 7 is a perspective view showing the configuration of the cooling mechanism included in the battery module according to the fourth embodiment of the present technology. As shown in FIG. 7, cooling mechanism 400C according to the present embodiment includes a cooling member 410C and a heat conduction member 420C.

Cooling member 410C in cooling mechanism 400C has a turning portion 414C. Turning portion 414C is connected to a flow path portion 411C and allows the cooling water to flow in an opposite direction between an upstream 412C and a downstream 413C.

Upstream 412C and downstream 413C are located on one side in the first direction (Y direction). Turning portion 414C is located on the other side in the first direction (Y direction). Thus, flow path portion 411C in the present embodiment forms a U-shape when viewed in the Z direction.

Heat conduction member 420C includes a first portion 421C, a second portion 422C, and a third portion 423C. First portion 421C is located between the battery cell and upstream 412C of cooling member 410C. Second portion 422C is located between the battery cell and downstream 413C of cooling member 410C. Third portion 423C is located between the battery cell and turning portion 414C.

The thickness of heat conduction member 420C is thinner in the direction from upstream 412C toward downstream 413C of flow path portion 411C. Specifically, in heat conduction member 420C, first portion 421C has a thickness t1, second portion 422C has a thickness t2, and third portion 423C has a thickness t3. The thicknesses in heat conduction member 420C satisfy a relation of t2<t3<t1.

In the battery module according to the fourth embodiment of the present technology, since cooling mechanism 400C has turning portion 414C, a cooling method by cooling mechanism 400C in the case where flow path portion 411C has a U-shape can be handled.

### Fifth Embodiment

Hereinafter, a battery module according to a fifth embodiment of the present technology will be described. Since the configurations of the restraint members and the cooling mechanism in the battery module according to the fifth embodiment of the present technology are different from those of battery module 1 according to the first embodiment of the present technology, the same configurations as those of battery module 1 according to the first embodiment of the present technology will not be described repeatedly.

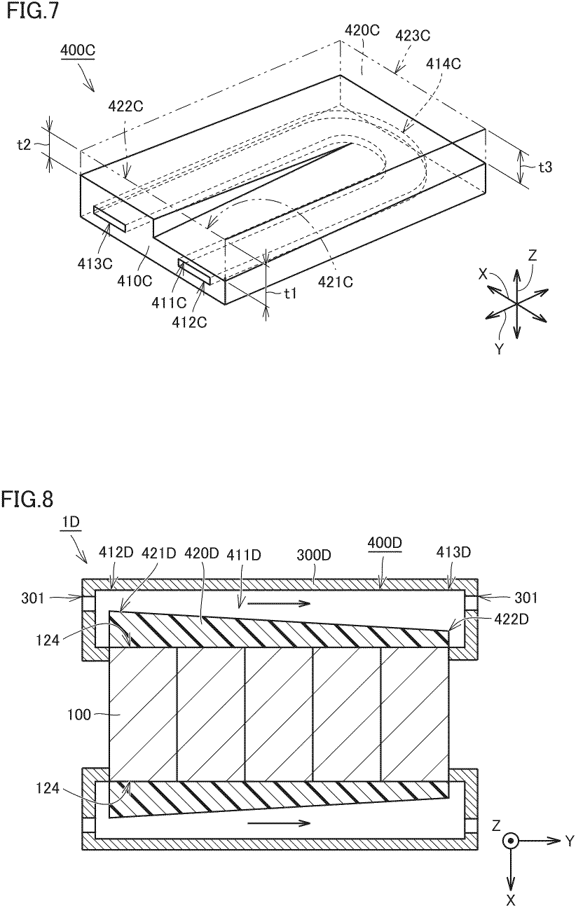

FIG. 8 is a cross sectional view showing the configuration of the battery module according to the fifth embodiment of the present technology. In FIG. 8, the end plates are not illustrated.

A battery module 1D according to the present embodiment includes battery cells 100, restraint members 300D, and cooling mechanisms 400D.

Each of restraint members 300D is provided with openings 301 at both ends in the first direction (Y direction). Each of openings 301 connects between external and internal spaces of restraint member 300D.

Cooling mechanism 400D is provided inside restraint member 300D. Cooling mechanism 400D is provided on the side surface side. In the present embodiment, cooling mechanisms 400D are provided on the pair of short side surfaces 124 sides of each of battery cells 100.

Cooling mechanism 400D is provided with a flow path portion 411D. The cooling water flows from an upstream 412D to a downstream 413D in flow path portion 411D. Heat conduction member 420D includes a first portion 421D and a second portion 422D. First portion 421D is located on the upstream 412D side. Second portion 422D is located on the downstream 413D side.

The thickness of heat conduction member 420 in the present embodiment is thinner at second portion 422D than that at first portion 421D. Thus, the heat resistance of cooling mechanism 400D with respect to the plurality of battery cells 100 is decreased in the direction from upstream 412D toward downstream 413D of flow path portion 411D.

In battery module 1D according to the fifth embodiment of the present technology, since cooling mechanisms 400D are disposed on the side surface sides of battery cell 100, occurrence of temperature variation among the plurality of battery cells 100 can be suppressed.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery module comprising:
a plurality of battery cells arranged side by side in a first direction; and
a cooling mechanism that is disposed adjacent to each of the plurality of battery cells and that cools the plurality of battery cells, wherein
the cooling mechanism includes a flow path portion through which cooling water is able to flow, the flow path portion extending inside the cooling mechanism along each of the plurality of battery cells in the first direction, and
heat resistance of the cooling mechanism with respect to the plurality of battery cells is decreased in a direction from an upstream toward a downstream of the flow path portion.

2. The battery module according to claim 1, wherein
the cooling mechanism further includes
a cooling member provided with the flow path portion, and
a heat conduction member disposed adjacent to the plurality of battery cells and the cooling member and sandwiched between each of the plurality of battery cells and the cooling member, the heat conduction member having a heat conductivity lower than a heat conductivity of the cooling member, and
a thickness of the heat conduction member is thinner in the direction from the upstream toward the downstream of the flow path portion.

3. The battery module according to claim 2, wherein a thickness of the cooling member is thicker in the direction from the upstream toward the downstream of the flow path portion.

4. The battery module according to claim 1, wherein
the cooling mechanism further include
a cooling member provided with the flow path portion, and
a heat conduction member disposed adjacent to the plurality of battery cells and the cooling member and sandwiched between each of the plurality of battery cells and the cooling member, the heat conduction member having a heat conductivity lower than a heat conductivity of the cooling member, and
a region in which the plurality of battery cells and the heat conduction member are in contact is wider in the direction from the upstream toward the downstream of the flow path portion.

5. The battery module according to claim 2, wherein the heat conduction member is in a form of a sheet.

6. The battery module according to claim 3, wherein the heat conduction member is in a form of a sheet.

7. The battery module according to claim 4, wherein the heat conduction member is in a form of a sheet.

8. The battery module according to claim 2, wherein the heat conduction member is composed of a silicone-based resin curable from a gel state.

9. The battery module according to claim 3, wherein the heat conduction member is composed of a silicone-based resin curable from a gel state.

10. The battery module according to claim 4, wherein the heat conduction member is composed of a silicone-based resin curable from a gel state.

11. The battery module according to claim 1, wherein a cross sectional area of the flow path portion is smaller in the direction from the upstream toward the downstream of the flow path portion.

12. The battery module according to claim 1, wherein
the cooling mechanism has a turning portion that is connected to the flow path portion and that allows the cooling water to flow in an opposite direction between the upstream and the downstream,
the upstream and the downstream are located on one side in the first direction, and
the turning portion is located on the other side in the first direction.

13. The battery module according to claim 2, wherein
the cooling mechanism has a turning portion that is connected to the flow path portion and that allows the cooling water to flow in an opposite direction between the upstream and the downstream,
the upstream and the downstream are located on one side in the first direction, and
the turning portion is located on the other side in the first direction.

14. The battery module according to claim 3, wherein
the cooling mechanism has a turning portion that is connected to the flow path portion and that allows the cooling water to flow in an opposite direction between the upstream and the downstream,
the upstream and the downstream are located on one side in the first direction, and
the turning portion is located on the other side in the first direction.

15. The battery module according to claim 4, wherein
the cooling mechanism has a turning portion that is connected to the flow path portion and that allows the cooling water to flow in an opposite direction between the upstream and the downstream,
the upstream and the downstream are located on one side in the first direction, and
the turning portion is located on the other side in the first direction.

16. The battery module according to claim 5, wherein
the cooling mechanism has a turning portion that is connected to the flow path portion and that allows the cooling water to flow in an opposite direction between the upstream and the downstream,
the upstream and the downstream are located on one side in the first direction, and
the turning portion is located on the other side in the first direction.

17. The battery module according to claim 6, wherein
the cooling mechanism has a turning portion that is connected to the flow path portion and that allows the cooling water to flow in an opposite direction between the upstream and the downstream,
the upstream and the downstream are located on one side in the first direction, and
the turning portion is located on the other side in the first direction.

18. The battery module according to claim 7, wherein
the cooling mechanism has a turning portion that is connected to the flow path portion and that allows the cooling water to flow in an opposite direction between the upstream and the downstream,
the upstream and the downstream are located on one side in the first direction, and
the turning portion is located on the other side in the first direction.

19. The battery module according to claim 1, wherein
each of the plurality of battery cells includes a case body having an upper surface and a lower surface, the upper surface being a surface on which an electrode terminal is disposed, the lower surface being a surface opposite to the upper surface, and
the cooling mechanism is provided on the lower surface side.

20. The battery module according to claim 1, wherein
each of the plurality of battery cells includes a case body having an upper surface and a side surface, the upper surface being a surface on which an electrode terminal is disposed, the side surface being a surface intersecting the upper surface, and
the cooling mechanism is provided on the side surface side.
